(19) United States
(12) Patent Application Publication
(10) Pub. No.: US 2025/0260153 A1
(43) Pub. Date: Aug. 14, 2025

(54) ELECTRONIC DEVICE

(71) Applicant: Advanced Semiconductor Engineering, Inc., Kaohsiung (TW)

(72) Inventors: Wei-Hao CHANG, Kaohsiung (TW); Nan-Yi WU, Kaohsiung (TW); Wei-Hong LAI, Kaohsiung (TW); Chin-Li KAO, Kaohsiung (TW)

(73) Assignee: Advanced Semiconductor Engineering, Inc., Kaohsiung (TW)

(21) Appl. No.: 18/437,171

(22) Filed: Feb. 8, 2024

(51) Int. Cl. H01Q 1/22; H01Q 1/52; H01Q 21/00; H01Q 21/28

(52) U.S. Cl. CPC H01Q 1/2283; H01Q 1/526; H01Q 21/28; H01Q 21/0087

(57) ABSTRACT

The present disclosure relates to an electronic device that includes a circuit structure and an antenna component attached to the circuit structure by a connection layer. The connection layer includes a plurality of portions spaced apart from each other and configured to mitigate stress between the circuit structure and the antenna component.

### BACKGROUND

### 1. Technical Field

The present disclosure generally relates to an electronic device and a method for manufacturing the same, and more particularly to an electronic device including multiple antenna components separated from each other and a method for manufacturing the same.

### 2. Description of the Related Art

Wireless communication devices, such as smart phones, normally include antennas for transmitting and receiving radio frequency (RF) signals. A wireless communication device normally includes an antenna substrate and a communication substrate. The antenna substrate and the communication substrate both include material having low dielectric constant (Dk) and low dissipation factor (Df). For different functional requirements, the antenna substrate and the communication substrate include different materials. Due to different material properties, such as coefficient of thermal expansion (CTE), of dielectric layer(s) of the antenna substrate and the communication substrate, the stress may exist between the antenna substrate and the communication substrate, thereby leading to warpage issue. In some case, the warpage may then cause delamination issue. Therefore, an improved electronic device package is needed.

### SUMMARY

In some embodiments, an electronic device includes a circuit structure and an antenna component attached to the circuit structure by a connection layer. The connection layer includes a plurality of portions spaced apart from each other and configured to mitigate stress between the circuit structure and the antenna component.

In some embodiments, an electronic device includes a circuit structure, a plurality of antenna units spaced apart from each other, and an isolation structure disposed between the plurality of antenna units and separating the plurality of antenna units. The isolation structure is configured to release the stress between the circuit structure and the first antenna component.

In some embodiments, an electronic device includes a circuit structure, a connection layer disposed over the circuit structure, and an antenna component attached to the circuit structure by the connection layer. A part of a top surface of the connection layer is exposed by the antenna component.

### BRIEF DESCRIPTION OF THE DRAWINGS

Aspects of the present disclosure are readily understood from the following detailed description when read with the accompanying figures. It should be noted that various features may not be drawn to scale. The dimensions of the various features may be arbitrarily increased or reduced for clarity of discussion.

FIG. 1 is a cross-section of an electronic device, in accordance with some embodiments of the present disclosure.

FIG. 2 is a cross-section of an electronic device, in accordance with some embodiments of the present disclosure.

FIG. 3A is a schematic diagram of an electronic device, in accordance with some embodiments of the present disclosure.

FIG. 3B is a schematic diagram of an electronic device, in accordance with some embodiments of the present disclosure.

FIG. 4A, FIG. 4B, and FIG. 4C are enlarged perspective views of a region “40” in FIG. 2, in accordance with different embodiments of the present disclosure, respectively.

FIG. 5A is a stress simulation diagram of an interconnector of an electronic device, in accordance with some embodiments of the present disclosure.

FIG. 5B is a stress simulation diagram of an interconnector of an electronic device, in accordance with some embodiments of the present disclosure.

FIG. 6A is a photo showing a defect of an electronic device.

FIG. 6B is a photo showing a well-adhered interconnect of an electronic device.

FIG. 7 is a cross-section of an electronic device, in accordance with some embodiments of the present disclosure.

FIG. 8 is a cross-section of an electronic device, in accordance with some embodiments of the present disclosure.

FIG. 8A is an enlarged perspective view of a region “80A” in FIG. 8, in accordance with some embodiments of the present disclosure.

FIG. 9A, FIG. 9B, FIG. 9C, FIG. 9D, FIG. 9E, FIG. 9F, FIG. 9G, and FIG. 9H illustrate one or more operations of a method for manufacturing an electronic device, in accordance with some embodiments of the present disclosure.

Common reference numerals are used throughout the drawings and the detailed description to indicate the same or similar elements. The present disclosure will be more apparent from the following detailed description taken in conjunction with the accompanying drawings.

### DETAILED DESCRIPTION

The following disclosure provides different embodiments, or examples, for implementing different features of the provided subject matter. Specific examples of components and embodiments are recited herein. These are, of course, merely examples and are not intended to be limiting. In the present disclosure, reference to the formation of a first feature over or on a second feature in the description that follows may include embodiments in which the first and second features are formed in direct contact, and may also include embodiments in which additional features may be formed between the first and second features, such that the first and second features may not be in direct contact. The present disclosure may repeat reference numerals and/or letters in the various examples. This repetition is for simplicity and clarity and does not in itself dictate a relationship between the various embodiments and/or configurations discussed.

Embodiments of the present disclosure are discussed in detail as follows. It should be appreciated, however, that the present disclosure provides many applicable concepts that can be embodied in a wide variety of specific contexts. The specific embodiments discussed are merely illustrative and do not limit the scope of the disclosure.

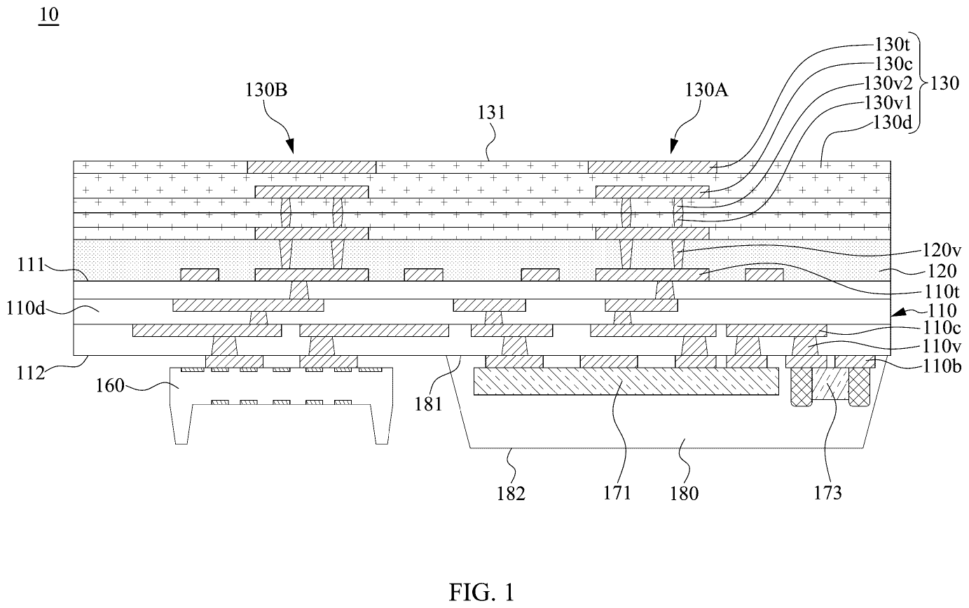

FIG. 1 is a cross-section of an electronic device 10, in accordance with some embodiments of the present disclosure. In some embodiments, the electronic device 10 may include a semiconductor device or a semiconductor device package. In some embodiments, the electronic device 10 may include a wireless transceiver device or a wireless communication device. In some embodiments, the electronic device 10 may be configured to operate with electromagnetic waves or electromagnetic signals at appropriate radio wavelengths, such as microwave, millimeter wave, or submillimeter wave.

Referring to FIG. 1, the electronic device 10 may include a circuit structure 110, a bonding layer 120, an antenna substrate 130, a connector 160, electronic components 171 and 173, and an encapsulant 180. The electronic device 10 may include, but is not limited to, an antenna device package.

The circuit structure 110 may be referred to as a substrate, a communication substrate, or the like. In one embodiment, the circuit structure 110 may be a core substrate, which includes a core layer (not shown) and a plurality of dielectric layers (not shown) disposed on opposite sides of the core layer. In some embodiments, the circuit structure 110 may be a multilayered substrate. The circuit structure 110 may include one or more dielectric layers 110d, conductive layer(s) 110c formed in the dielectric layers 110d, and conductive via(s) 110v formed between the conductive layers 110c. The dielectric layers 110d may be a multilayered structure. The conductive vias 110v may penetrate a portion of the dielectric layers 110d, and electrically connect the corresponding conductive layers 110c. In some embodiments, the conductive vias 110v may penetrate one of the dielectric layers 110d, and electrically connect the corresponding conductive layers 110c. In some embodiments, the conductive vias 110v may include a copper (Cu) pillar.

The circuit structure 110 may include one or more pads 110t disposed on a top surface 111 of the topmost one of the dielectric layers 110d. The pads 110t can protrude from the top surface of the topmost one of the dielectric layers 110d. In another embodiment, the pads 110t may be embedded in the topmost one of the dielectric layers 110d and the top surface of the pads 110t may be exposed by the topmost one of the dielectric layers 110d. In some embodiments, the circuit structure 110 may include one or more pads 110b disposed on a bottom surface 112 of the bottommost one of the dielectric layers 110d. The pads 110b can protrude from the bottom surface of the bottommost one of the dielectric layers 110d. In another embodiment, the pads 110b may be embedded in the bottommost one of the dielectric layers 110d and the bottom surface of the pads 110b may be exposed by the bottommost one of the dielectric layers 110d.

The conductive layers 110c, the pads 110t and 110b may each include a conductive material such as a metal or metal alloy. Examples of the conductive material include gold (Au), silver (Ag), aluminum (Al), copper (Cu), or an alloy thereof. The dielectric layers 110d may include organic material. In some embodiments, the dielectric layers 110d may be Bismaleimide Triazine resin (BT-epoxy).

In some embodiments, the antenna substrate 130 may be disposed on the top surface 111 of the circuit structure 110. The antenna substrate 130 may be a pre-formed structure. The antenna substrate 130 may be attached to the circuit structure 110 by the bonding layer 120.

In some embodiments, the antenna substrate 130 may include one or more antenna components 130A and 130B, and one or more dielectric layers 130d covering the antenna components 130A and 130B. The dielectric layers 130d may be a multilayered structure. The material of the dielectric layers 130d may include organic material. Each of the antenna components 130A and 130B may include one or more conductive layers 130c, a top conductive layer 130t, and conductive vias 130v1 and 130v2. In some embodiments, the antenna components 130A and 130B may form an antenna array. The conductive layers 130c may be formed in the dielectric layers 130d, and conductive vias 130v1 and 130v2 formed between the conductive layers 130c. The conductive vias 130v1 and 130v2 may penetrate a portion of the dielectric layers 130d, and electrically connect the corresponding conductive layers 130c. In some embodiments, the conductive vias 130v1 and 130v2 may penetrate one of the dielectric layers 130d, and electrically connect the corresponding conductive layers 130c. The conductive vias 130v1 and 130v2 may be the feeding vias electrically connecting the electronic component 171 and the antenna pattern defined by the conductive layer 130c.

The conductive vias 130v1 may be disposed between the conductive layers 130c. The conductive vias 130v2 may be disposed on the conductive vias 130v1. The conductive vias 130v1 and 130v2 may be aligned. The conductive vias 130v1 and 130v2 may taper in an opposite direction. For example, the conductive via 130v1 tapers toward the below conductive layer 130c (i.e., toward the bonding layer 120), and the conductive via 130v2 tapers toward the top conductive layer 130t. In another embodiment, the conductive vias 130v1 and 130v2 may taper in the same direction (not shown). In some embodiments, the conductive layers 130c may be embedded in the dielectric layers 130d. In some embodiments, the conductive layers 130c may define an antenna pattern.

The top conductive layer 130t may be disposed on a side of the antenna substrate 130 opposite to the top surface 111 of the circuit structure 110. The top conductive layer 130t can protrude from the top surface 131 of the topmost one of the dielectric layers 130d. In another embodiment, the top conductive layer 130t may be embedded in the topmost one of the dielectric layers 130d and the top surface of the top conductive layer 130t may be exposed by the topmost one of the dielectric layers 130d. The top surface of the top conductive layer 130t may be substantially aligned with the top surface 131 of the topmost one of the dielectric layers 130d. In some embodiments, the top conductive layer 130t may be a patch antenna. The top conductive layer 130t may be a stacked patch or a director coupled to the antenna pattern (i.e., the conductive layer 130c) to enhance the bandwidth and gain of the antenna.

The conductive layers 130c, the top conductive layer 130t, and the conductive vias 130v1 and 130v2 may each include a conductive material such as a metal or metal alloy. Examples of the conductive material include gold (Au), silver (Ag), aluminum (Al), copper (Cu), or an alloy thereof. The dielectric layers 130d may include organic material. In some embodiments, the dielectric layers 130d may be liquid crystal polymers (LCP).

The bonding layer 120 may be disposed between the antenna substrate 130 and the circuit structure 110. The bonding layer 120 may include a bonding material suitable to adhere the antenna substrate 130 and the circuit structure 110. The bonding layer 120 may be a connection layer to connect the antenna substrate 130 and the circuit structure 110. In some embodiments, the bonding layer 120 is softer than the circuit structure 110 and the antenna substrate 130, and thus a modulus of elasticity of the bonding layer 120 is lower than that of the circuit structure 110 and the antenna substrate 130.

The bonding layer 120 may include one or more interconnectors 120v disposed between the circuit structure 110 and the antenna substrate 130. In some embodiments, the interconnectors 120v may be disposed on and contact the pad 110t. In some embodiments, the interconnectors 120v may connect a lowermost conductive layer 130c of the antenna substrate 130 and the pad 110t of the circuit structure 110. The interconnectors 120v may electrically connect the circuit structure 110 and the antenna substrate 130. In some embodiments, the interconnectors 120v may be conductive vias or pillars, such as conductive paste filling (CPF). In other embodiments, the interconnectors 120v may include solder conductive structures such as solder bumps or solder ball, or non-solder conductive structures such as copper pillar, or a combination thereof.

In some embodiments, the connector 160 may be disposed on the bottom surface 112 of the circuit structure 110. The connector 160 may be electrically connected to the circuit structure 110 through the pads 110b. In some embodiments, the connector 160 may be electrically connected to the circuit structure 110 through solder material, such as solder balls (not shown). The connector 160 may be configured to connect the electronic device 10 to external components (not shown).

In some embodiments, the electronic components 171 and 173 may be disposed on the bottom surface 112 of the circuit structure 110. In some embodiments, each of the electronic components 171 and 173 may have an active surface facing the bottom surface 112 of the circuit structure 110. The electronic components 171 and 173 may be electrically connected to the circuit structure 110 through the pads 110b. In some embodiments, the electronic components 171 and 173 may be electrically connected to the circuit structure 110 through solder material, such as solder balls (not shown). For example, the solder balls may be disposed between the pads 110b and the electronic component 171 and between the pads 110b and the electronic component 173. In some embodiments, the electronic component 171 may be an active component, such as an IC or a die. The electronic component 173 may be a passive component, such as a capacitor, a resistor or an inductor.

The electronic components 171 and 173 may be encapsulated by an encapsulant 180. The encapsulant 180 may be disposed on the bottom surface 112 of the circuit structure 110. The encapsulant 180 may cover a portion of the bottom surface 112 of the circuit structure 110. The encapsulant 180 may be disposed between the electronic component 171 and the bottom surface 112 of the circuit structure 110. The encapsulant 180 may be disposed between the electronic component 173 and the bottom surface 112 of the circuit structure 110. In some embodiments, the material of the encapsulant 180 may include molding compound. The encapsulant 180 may be a cured molding compound with or without fillers. In some embodiments, the material of the encapsulant 180 may include organic material.

The encapsulant 180 may have a top surface 181 and a bottom surface 182 opposite to the top surface 181. The top surface 181 of the encapsulant 180 may be substantially coplanar to the bottom surface 112 of the circuit structure 110. The encapsulant 180 may taper toward the bottom surface 182. In some embodiments, an upper width of the encapsulant 180 adjacent to the circuit structure 110, about the top surface 181, is greater than a lower width of the encapsulant 180 away from the circuit structure 110, about the bottom surface 182.

In some embodiments, the dielectric constant (Dk) of the dielectric layers 130d of the antenna substrate 130 is less than the dielectric constant (Dk) of the dielectric layers 110d of the circuit structure 110. By choosing the antenna substrate 130 having the relatively lower Dk, the electrical performance of the antenna pattern (e.g., the conductive layer 10c) can be improved. The dielectric layers 110d has a first coefficient of thermal expansion (CTE), and a first modulus of elasticity. The dielectric layers 130d has a second CTE, and a second modulus of elasticity. The first CTE and the second CTE may be different, which may cause stress between the circuit structure 110 and the antenna substrate 130. In some embodiments, the stress may be accumulated around the interface of the bonding layer 120 and the circuit structure 110 and/or the interface of the bonding layer 120 and the antenna substrate 130. In such a case, the difference between the first CTE and the second CTE may lead to high stress in the interconnector 120v, and delamination may occur. The delamination may occur at the interface of the bonding layer 120 and the circuit structure 110 and/or the interface of the bonding layer 120 and the antenna substrate 130.

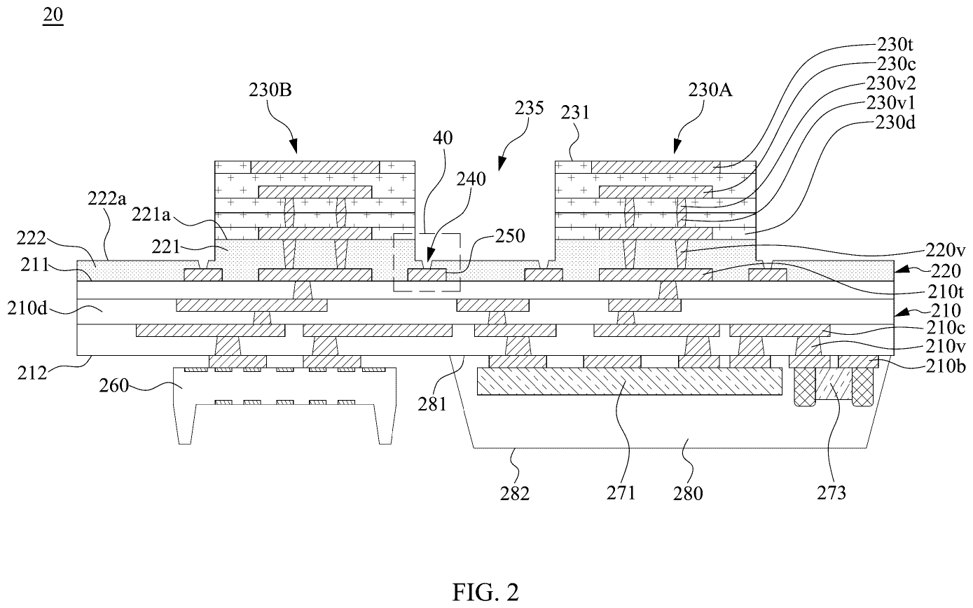

FIG. 2 is a cross-section of an electronic device 20, in accordance with some embodiments of the present disclosure. Referring to FIG. 2, the electronic device 20 may include a circuit structure 210, a bonding layer 220, antenna components 230A and 230B, a connector 260, electronic components 271 and 273, and an encapsulant 280. The electronic device 20 may include, but is not limited to, an antenna device package.

The circuit structure 210 may be referred to as a substrate, a communication substrate, or the like. In one embodiment, the circuit structure 210 may be a core substrate, which includes a core layer (not shown) and a plurality of dielectric layers (not shown) disposed on opposite sides of the core layer. In some embodiments, the circuit structure 210 may be a multilayered substrate. The circuit structure 210 may include one or more dielectric layers 210d, conductive layer(s) 210c formed in the dielectric layers 210d, and conductive via(s) 210v formed between the conductive layers 210c. The material of the dielectric layers 210d may include organic material. In some embodiments, the dielectric layers 210d may be Bismaleimide Triazine resin (BT-epoxy). The conductive vias 210v may penetrate a portion of the dielectric layers 210d, and electrically connect the corresponding conductive layers 210c. In some embodiments, the conductive vias 210v may penetrate one or more of the dielectric layers 210d, and electrically connect the corresponding conductive layers 210c. In some embodiments, the conductive vias 210v may include a copper (Cu) pillar.

The circuit structure 210 may include one or more pads 210t disposed on a top surface 211 of the topmost one of the dielectric layers 210d. The pads 210t can protrude from the top surface of the dielectric layers 210d. In another embodiment, the pads 210t may be embedded in the topmost one of the dielectric layers 210d and the top surface of the pads 210t may be exposed by the topmost one of the dielectric layers 210d. In some embodiments, the circuit structure 210 may include one or more pads 210b disposed on a bottom surface 212 of the bottommost one of the dielectric layers 210d. The pads 210b can protrude from the bottom surface of the dielectric layers 210d. In another embodiment, the pads 210b may be embedded in the bottommost one of the dielectric layers 210d and the bottom surface of the pads 210b may be exposed by the bottommost one of the dielectric layers 210d.

The circuit structure 210 may include one or more conductive elements 250 disposed on a top surface 211 of the topmost one of the dielectric layers 210d. The conductive elements 250 may be arranged in a predetermined pattern. In some embodiments, the conductive elements 250 may be a stop layer for process (such as laser drilling) needs. The stop layer is configured to avoid damaging the dielectric layers and impacting the reliability thereof, so as to avoid defects (for example, delamination issues. In some embodiments, the conductive elements 250 may be free from electrical connection, and thus may be referred to as a dummy conductive element. In another embodiment, the conductive elements 250 may be configured to be a ground terminal. In some embodiments, the conductive elements 250 may surround the antenna components 230A and 230B. The conductive elements 250 may be formed with the pads 210t in the same process.

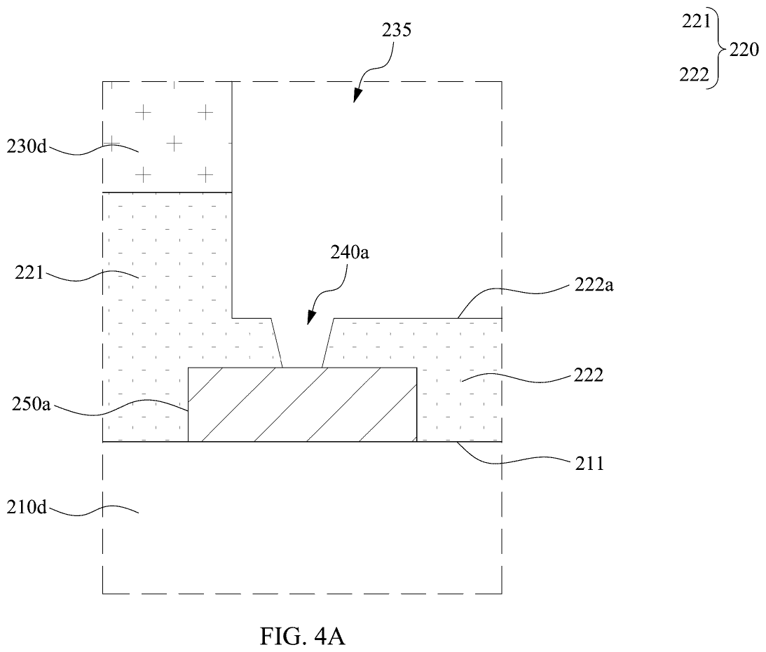

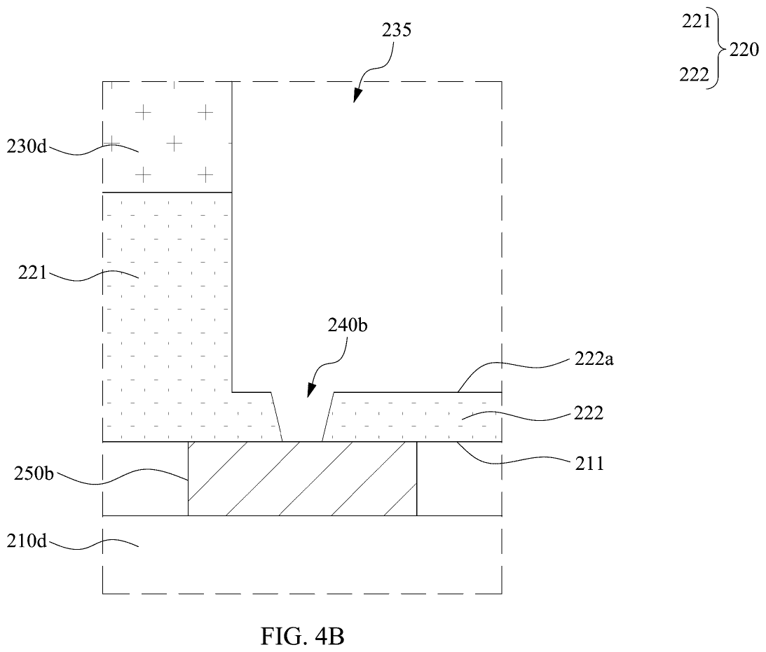

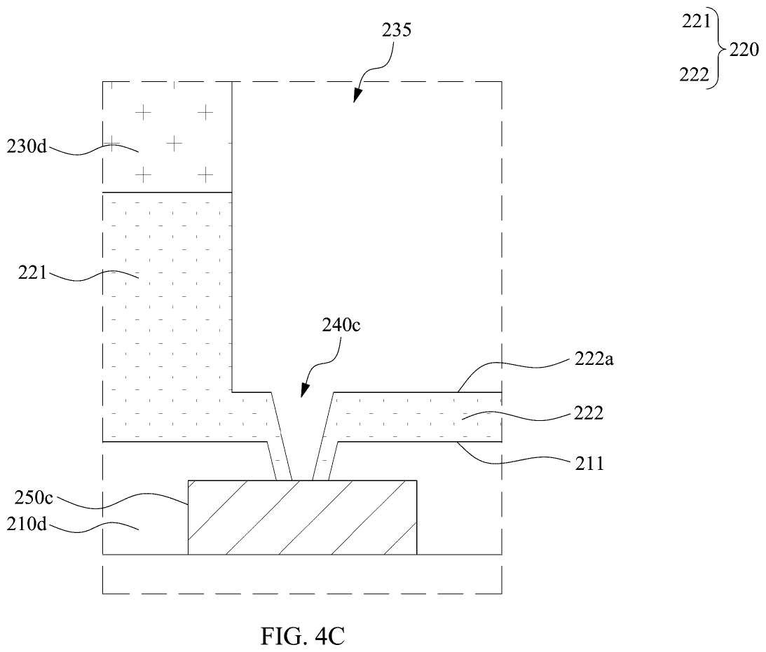

The conductive elements 250 can protrude from the top surface 211 of the topmost one of the dielectric layers 210d. In another embodiment, the conductive elements 250 may be embedded in the topmost one of the dielectric layers 210d and the top surface of the conductive elements 250 may be exposed by the topmost one of the dielectric layers 210d. Details of the different embodiments of the conductive elements 250 are provided in FIGS. 4A-4C.

The conductive layers 210c, the conductive elements 250, and the pads 210t and 210b may each include a conductive material such as a metal or metal alloy. Examples of the conductive material include gold (Au), silver (Ag), aluminum (Al), copper (Cu), or an alloy thereof.

In some embodiments, the antenna components 230A and 230B may be disposed on the top surface 211 of the circuit structure 210. The antenna components 230A and 230B may be a pre-formed structures. The antenna components 230A and 230B may be attached to the circuit structure 210 by the bonding layer 220. The antenna components 230A and 230B may be electrically connected to the circuit structure 210.

Each of the antenna components 230A and 230B may include one or more conductive layers 230c, a top conductive layer 230t, conductive vias 230v1 and 230v2, and one or more dielectric layers 230d covering the conductive layers 230c, the top conductive layer 230t and the conductive vias 230v1 and 230v2. The dielectric layers 230d are stacked one another to form a multilayered structure. In some embodiments, the antenna components 230A and 230B may form an antenna array. The material of the dielectric layers 230d may include organic material. In some embodiments, the dielectric layers 230d may be liquid crystal polymers (LCP).

The conductive layers 230c may be formed in the dielectric layers 230d, and conductive vias 230v1 and 230v2 formed between the conductive layers 230c. The conductive vias 230v1 and 230v2 may penetrate a portion of the dielectric layers 230d, and electrically connect the corresponding conductive layers 230c. The conductive vias 230v1 and 230v2 may penetrate one or more of the dielectric layers 230d, and electrically connect the corresponding conductive layers 230c. The conductive vias 230v1 and 230v2 may be the feeding vias electrically connecting the electronic component 271 and the antenna pattern defined by the conductive layer 230c.

The conductive vias 230v1 may be disposed between the conductive layers 230c. The conductive vias 230v2 may be disposed on the conductive vias 230v1. The conductive vias 230v1 and 230v2 may be aligned. The conductive vias 230v1 and 230v2 may taper in an opposite direction. For example, the conductive via 230v1 may taper toward the lowermost conductive layer 230c, and the conductive via 230v2 may taper toward the top conductive layer 230t. In another embodiment, the conductive vias 230v1 and 230v2 may taper in the same direction (not shown). In some embodiments, the conductive layers 230c may be embedded in the dielectric layers 230d. In some embodiments, the conductive layers 230c may define an antenna pattern.

The top conductive layer 230t may be disposed on a side of the antenna components 230A and 230B opposite to the top surface 211 of the circuit structure 210. The top conductive layer 230t can protrude from the top surface 231 of the dielectric layers 230d. In another embodiment, the top conductive layer 230t may be embedded in the dielectric layers 230d, and the top surface of the top conductive layer 230t may be exposed by the dielectric layers 230d. The top surface of the top conductive layer 230t may be substantially aligned with the top surface 231 of the dielectric layers 230d. In some embodiments, the top conductive layer 230t may be a patch antenna. The top conductive layer 230t may be a stacked patch or a director coupled to the antenna pattern (i.e., the conductive layer 230c) to enhance the bandwidth and gain of the antenna.

The conductive layers 230c, the top conductive layer 230t, and the conductive vias 230v1 and 230v2 may each include a conductive material such as a metal or metal alloy. Examples of the conductive material include gold (Au), silver (Ag), aluminum (Al), copper (Cu), or an alloy thereof.

The antenna components 230A and 230B may be multi antenna stacked architecture. In some embodiments, the antenna components 230A and 230B may be a dual antenna arrangement, which has a low frequency antenna and a high frequency antenna stacked on the low frequency antenna. For example, the top conductive layer 230t may define a high frequency antenna pattern, and the conductive layer 230c may define a low frequency antenna pattern. In such a case, the size of the high frequency antenna pattern is less than that of the low frequency antenna pattern. That is, the width of the high frequency antenna pattern is less than that of the low frequency antenna pattern in a cross-sectional view.

The bonding layer 220 may be disposed on the circuit structure 210. The bonding layer 220 may be disposed between the antenna components 230A and 230B and the circuit structure 210. The bonding layer 220 may include a bonding material suitable to adhere the dielectric layers 230d of the antenna components 230A and 230B and the dielectric layers 210d of the circuit structure 210. The bonding layer 220 may be a connection layer to connect the antenna components 230A and 230B and the circuit structure 210. The dielectric layers 230d and the bonding layer 220 are stacked one another. In some embodiments, the bonding layer 220 is softer than the dielectric layers 230d of the antenna components 230A and 230B and the dielectric layers 210d of the circuit structure 210, and thus a modulus of elasticity of the bonding layer 220 is lower than that of the dielectric layers 230d of the antenna components 230A and 230B and the dielectric layers 210d of the circuit structure 210.

The bonding layer 220 may include a plurality of portions 221 and 222 spaced apart from each other and configured to mitigate stress between the circuit structure 210 and the antenna component 230A/230B. The bonding layer 220 may include a first portion 221 and a second portion 222. The first portion 221 of the bonding layer 220 may be disposed directly under the antenna components 230A and 230B. That is, the first portion 221 of the bonding layer 220 may be disposed between the antenna component 230A and the circuit structure 210, such that the antenna component 230A can be attached to the circuit structure 210 through the first portion 221 of the bonding layer 220. Similarly, the first portion 221 of the bonding layer 220 may be disposed between the antenna component 230B and the circuit structure 210, such that the antenna component 230B can be attached to the circuit structure 210 through the first portion 221 of the bonding layer 220.

The first portion 221 of the bonding layer 220 may include one or more interconnectors 220v disposed between the circuit structure 210 and the antenna components 230A and 230B. In some embodiments, the interconnectors 220v may be disposed on and contact the pads 210t. In some embodiments, the interconnectors 220v may connect the conductive layer 230c of the antenna component 230A or 230B to the pads 210t of the circuit structure 210. The interconnectors 220v may electrically connect the circuit structure 210 to the antenna component 230A or 230B. In some embodiments, the interconnectors 220v may be conductive vias or pillars, such as conductive paste filling (CPF). The interconnectors 220v may include solder conductive structures such as solder bumps or solder ball, or non-solder conductive structures such as copper pillar, or a combination thereof.

The second portion 222 of the bonding layer 220 may be disposed on the circuit structure 210. The second portion 222 of the bonding layer 220 may surround the antenna components 230A and 230B. In some embodiments, the second portion 222 of the bonding layer 220 may be exposed by the antenna components 230A and 230B. The second portion 222 of the bonding layer 220 may non-overlap the antenna components 230A and 230B vertically. That is, the projection of the antenna components 230A and 230B on the circuit structure 210 is apart from the projection of the second portion 222 of the bonding layer 220 on the circuit structure 210. The second portion 222 of the bonding layer 220 may be referred to as an isolation structure for separating the antenna components 230A and 230B. The second portion 222 of the bonding layer 220 may be disposed between the antenna components 230A and 230B and separating them.

The top surface 221a of the first portion 221 of the bonding layer 220 may be substantially coplanar with the bottom surface of the antenna components 230A and 230B. The elevation of the top surface 222a of the second portion 222 of the bonding layer 220 may be lower than the elevation of the top surface 221a of the first portion 221 of the bonding layer 220 with respect to the circuit structure 210. In some embodiments, a thickness of the second portion 222 of the bonding layer 220 may be less than a thickness of the first portion 221 of the bonding layer 220. In another embodiment, the top surface 222a of the second portion 222 of the bonding layer 220 may be substantially aligned with the top surface 221a of the first portion 221 of the bonding layer 220 (not shown). That is, the thickness of the second portion 222 of the bonding layer 220 may be substantially identical to the thickness of the first portion 221 of the bonding layer 220 (not shown).

In some embodiments, the bonding layer 220 may include one or more recesses 240. The first portion 221 and the second portion 222 of the bonding layer 220 may be separated by the recess 240, and thus the antenna substrate 230 is separated into antenna components 230A and 230B (or antenna units). The recesses 240 may surround the antenna components 230A and 230B. The recess 240 may be adjacent to an edge of the antenna components 230A and 230B. In other embodiments, the recess 240 may have a lateral surface substantially aligned with a lateral surface of the antenna components 230A and 230B (not shown). The recesses 240 may penetrate the bonding layer 220 and expose a part of the top surface of the conductive elements 250. In some embodiments, the recesses 240 may be formed by a laser saw process. The recess 240 may be configured to mitigate stress between the circuit structure 210 and the antenna component 230A/230B. The details of the recesses 240 will be elaborated in FIGS. 4A-4C.

In some embodiments, the antenna substrate 230 includes antenna components 230A and 230B and a recess (or a trench) disposed between the antenna components 230A and 230B and separating them. In some embodiments, the recess 235 (or a trench) may be formed between the antenna components 230A and 230B. The recess 235 may be connected to the recess 240 of the bonding layer 220. In some embodiments, the recess 235 (including air space therein) may be referred to as an isolation structure for separating the antenna components 230A and 230B. The recess 235 may be defined by the second portion 222 of the bonding layer 220 and the antenna components 230A and 230B. Having the recess 235, the bonding area between the circuit structure 210 and the antenna component 230A/230B may be decreased. The recess 235 may be configured to release the stress between the circuit structure 210 and the antenna component 230A/230B. In some embodiments, the recess 235 may be configured to mitigate electromagnetic interference between the antenna components 230A and 230B.

In some embodiments, the connector 260 may be disposed on the bottom surface 212 of the circuit structure 210. The connector 260 may be electrically connected to the circuit structure 210 through the pads 210b. In some embodiments, the connector 260 may be electrically connected to the circuit structure 210 through solder material, such as solder balls (not shown). The connector 260 may be configured to connect the electronic device 20 to external components (not shown).

In some embodiments, the electronic components 271 and 273 may be disposed on the bottom surface 212 of the circuit structure 210. In some embodiments, each of the electronic components 271 and 273 may have an active surface facing the bottom surface 212 of the circuit structure 210. The electronic components 271 and 273 may be electrically connected to the circuit structure 210 through the pads 210b. In some embodiments, the electronic components 271 and 273 may be electrically connected to the circuit structure 210 through solder material, such as solder balls (not shown). For example, the solder balls may be disposed between the pads 210b and the electronic component 271 and between the pads 210b and the electronic component 273. In some embodiments, the electronic component 271 may be an active component, such as an IC or a die. The electronic component 273 may be a passive component, such as a capacitor, a resistor or an inductor.

The electronic components 271 and 273 may be encapsulated by an encapsulant 280. The encapsulant 280 may be disposed on the bottom surface 212 of the circuit structure 210. The encapsulant 280 may cover a portion of the bottom surface 212 of the circuit structure 210. The encapsulant 280 may be disposed between the electronic component 271 and the bottom surface 212 of the circuit structure 210. The encapsulant 280 may be disposed between the electronic component 273 and the bottom surface 212 of the circuit structure 210. In some embodiments, the material of the encapsulant 280 may include molding compound. The encapsulant 280 may be a cured molding compound with or without fillers. In some embodiments, the material of the encapsulant 280 may include organic material.

The encapsulant 280 may have a top surface 281 and a bottom surface 282 opposite to the top surface 281. The top surface 281 of the encapsulant 280 may be substantially coplanar to the bottom surface 212 of the circuit structure 210. The encapsulant 280 may taper toward the bottom surface 282. In some embodiments, an upper width of the encapsulant 280 adjacent to the circuit structure 210, about the top surface 281, is greater than a lower width of the encapsulant 280 away from the circuit structure 210, about the bottom surface 282.

In some embodiments, the dielectric constant (Dk) of the dielectric layers 230d is less than the dielectric constant (Dk) of the dielectric layers 210d of the circuit structure 210. By choosing the antenna substrate 230 having the relatively lower Dk, the electrical performance of the antenna pattern (e.g., the conductive layer 230c) can be improved. The dielectric layers 210d has a first coefficient of thermal expansion (CTE), and a first modulus of elasticity. The dielectric layers 230d has a second CTE, and a second modulus of elasticity. The first CTE and the second CTE may be different, which may cause the stress existing between the circuit structure 210 and the antenna substrate 230. In some embodiments, a difference between the first CTE of the dielectric layers 210d and the second CTE of the dielectric layers 230d may be greater than a difference between the third CTE of the bonding layer 220 and the first CTE of the dielectric layers 210d. In some embodiments, a difference between the third CTE of the bonding layer 220 and the second CTE of the dielectric layers 230d may be less than a difference between the third CTE of the bonding layer 220 and the first CTE of the dielectric layers 210d. In such a case, the bonding layer may be referred to as a buffer layer configured to mitigate the stress existing between the circuit structure 210 and the antenna substrate 230.

In some embodiments, stress from the mismatched CTE may accumulate around the interface of the bonding layer 220 and the circuit structure 210 and/or the interface of the bonding layer 220 and the antenna substrate 230. In such a case, the difference between the first CTE and the second CTE may lead to high stress in the interconnector 220v, and delamination may occur. The present disclosure provides an electronic device 20 with several recesses 235 and 240 removing a part of the dielectric layers 230d, such that the entire dielectric layers 230d can be separated into portions (such as those in the antenna components 230A and 230B), whereby the bonding area of the dielectric layers 210d and the dielectric layers 230d are decreased, and stress can be mitigated. The present several recesses 235 and 240 of the electronic device 20 may also remove a part of the bonding layer 220, such that the entire bonding layer 220 can be separated into portions (such as portions 221 and 222), whereby the bonding area of the dielectric layers 230d and the bonding layer 220 are decreased, and stress can be mitigated as well. The electronic device 20 includes less bonding area of the dielectric layers 210d and the dielectric layers 230d, whereby stress from the mismatch CTE may be decreased or eliminated. With the recesses 235 and 240, the accumulated stress between the circuit structure 210 and the antenna components 230A and 230B may be reduced more than 49%. Therefore, the warpage of the electronic device 20 may be improved. In addition, the delamination situation that occur between the circuit structure 210 and the antenna components 230A and 230B can be reduced.

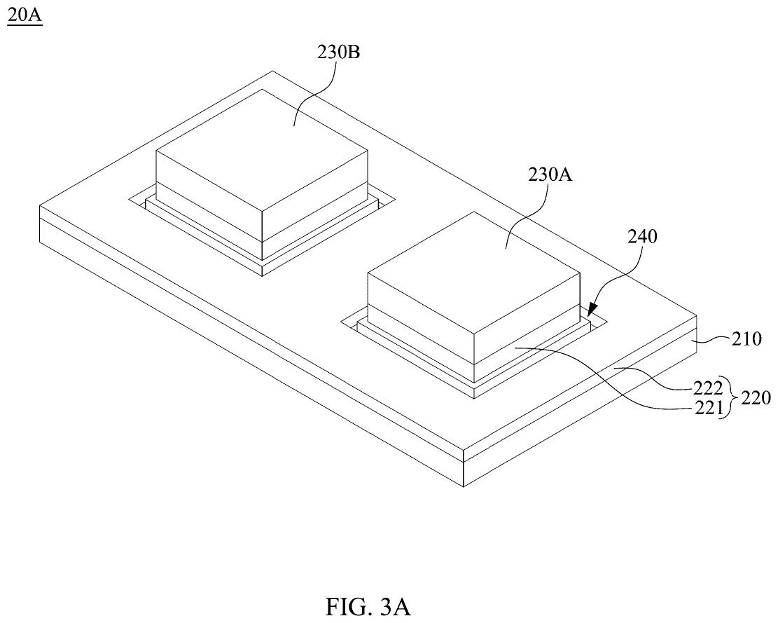

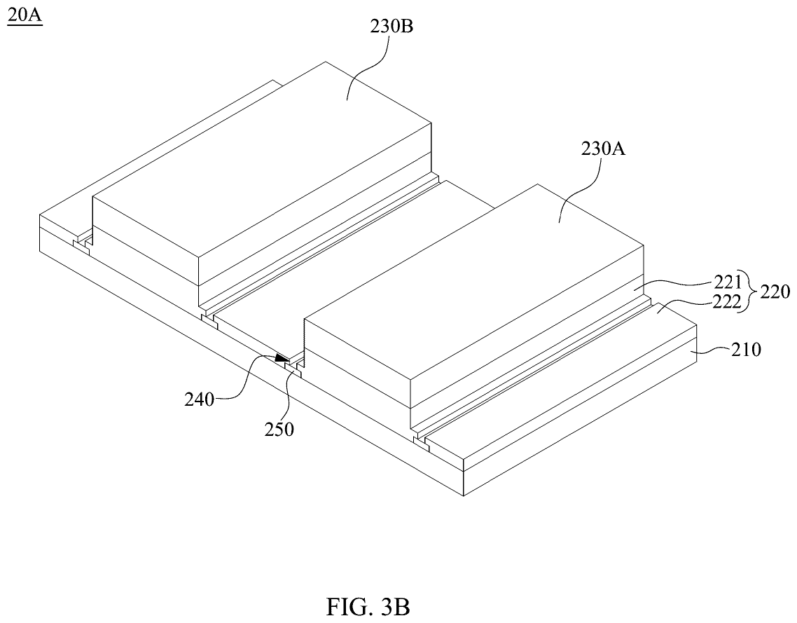

FIG. 3A is a schematic diagram of an electronic device 20A, in accordance with some embodiments of the present disclosure. FIG. 3A shows an embodiment of the electronic device 20 in FIG. 2. Referring to FIG. 3A, the recesses 240 of the electronic device 20A may surround the antenna components 230A and 230B. In some embodiments, the recesses 240 may encircle the antenna components 230A and 230B. For example, the recesses may be a shape of ring around the antenna components 230A and 230B in a top view. The recesses 240 may separate the bonding layer 220 to the first portion 221 and the second portion 222. In such a case, the second portion 222 may be around the first portion 221 of the bonding layer 220. The conductive elements 250 may correspond to the recesses 240, and thus the conductive elements 250 may surround the antenna components 230A and 230B (not shown). In some embodiments, the conductive elements 250 may encircle the antenna components 230A and 230B.

FIG. 3B is a schematic diagram of an electronic device 20B, in accordance with some embodiments of the present disclosure. FIG. 3B shows an embodiment of the electronic device 20 in FIG. 2. Referring to FIG. 3B, the recesses 240 of the electronic device 20B may be adjacent to the antenna components 230A and 230B. In some embodiments, the recesses 240 of the electronic device 20B may extend from a side to an opposite side of the electronic device 20B. In some embodiments, the recesses 240 may extend from a side to an opposite side of the bonding layer 220. In some embodiments, the recesses 240 may be a groove around the antenna components 230A and 230B. The recesses 240 may be disposed on opposite sides of the antenna component 230A. The recesses 240 may be disposed on opposite sides of the antenna component 230B. The recesses 240 may separate the bonding layer 220 to the first portion 221 and the second portion 222. In some embodiments, the trench 235 of the electronic device 20B may be adjacent to the antenna components 230A and 230B and extend from a side to an opposite side of the electronic device 20B. In some embodiments, the trench 235 may extend from a side to an opposite side of the bonding layer 220. In some embodiments, the extending direction of the trench 235 is substantially parallel to the extending direction of the recesses 240.

The conductive elements 250 may correspond to the recesses 240, and thus the conductive elements 250 may also be disposed adjacent to the antenna components 230A and 230B. In some embodiments, the conductive elements 250 may be a line adjacent to the antenna components 230A and 230B. The conductive elements 250 may be disposed on opposite sides of the antenna component 230A. The conductive elements 250 may be disposed on opposite sides of the antenna component 230B.

FIG. 4A, FIG. 4B, and FIG. 4C are enlarged perspective views of a region “40” in FIG. 2, in accordance with different embodiments of the present disclosure, respectively. FIGS. 4A, 4B, and 4C show arrangements of the conductive elements 250. Since the pads 210t may be formed along with the conductive elements 250, the same arrangements may be applicable to the pads 210t (not shown in FIGS. 4A, 4B, and 4C).

Referring to FIG. 4A, the conductive elements 250a may protrude from the top surface 211 of the dielectric layers 210d. The conductive element 250a may be disposed on the dielectric layers 210d and covered by the bonding layer 220. The recess 240a may penetrate the bonding layer 220 and expose a part of the conductive elements 250a. In some embodiments, the recess 240a tapers toward the dielectric layers 210d of the circuit structure 210. In some embodiments, the recesses 235 and 240b may be stepped. The recess 235 may form a first stage (i.e., the top surface 222a of the second portion 222 of the bonding layer 220) and the recess 240a may form a second stage (for example, the top surface of the conductive element 250a) recessed from the first stage.

Referring to FIG. 4B, the conductive elements 250b may be embedded in the dielectric layers 210d and the top surface of the conductive elements 250b may be exposed by the dielectric layers 210d. In some embodiments, the top surface of the conductive elements 250b may be substantially coplanar with the top surface 211 of the dielectric layers 210d. The conductive element 250b may be covered by the bonding layer 220. The recess 240b may penetrate the bonding layer 220 and expose a part of the conductive elements 250b. In some embodiments, the recess 240b tapers toward the dielectric layers 210d of the circuit structure 210. In some embodiments, the recesses 235 and 240b may be stepped. The recess 235 may form a first stage (for example, the top surface 222a of the second portion 222 of the bonding layer 220) and the recess 240b may form a second stage (for example, the top surface of the conductive element 250b) recessed from the first stage.

Referring to FIG. 4C, the conductive elements 250c may be embedded in the dielectric layers 210d and the top surface of the conductive elements 250c may be exposed by the dielectric layers 210d. In some embodiments, the top surface of the conductive elements 250c may be recessed from the top surface 211 of the dielectric layers 210d. That is, the top surface of the conductive elements 250c may be lower than the top surface 211 of the dielectric layers 210d. The conductive element 250c may be covered by the dielectric layers 210d. In some embodiments, a part of the dielectric layer 210d may be removed to expose a part of the top surface of the conductive elements 250s before the bonding layer 220 is formed on the dielectric layer 210d. That is, the dielectric layer 210d may have a recess, corresponding to the recess 240c, penetrating the dielectric layer 210d to expose the conductive elements 250c. In some embodiments, the dielectric layer 210d may be solder resist or solder mask.

The conductive element 250c may be covered by the bonding layer 220. In some embodiments, the conductive element 250c may contact the bonding layer 220. In some embodiments, the bonding layer 220 may be disposed on the dielectric layer 210d, and then the recess 240c may be formed by the removal process to expose the conductive elements 250c. The recess 240c may penetrate the bonding layer 220 and expose a part of the conductive elements 250c. In some embodiments, the recess 240c may correspond to the recess of the dielectric layer 210d. The bonding layer 220 may extend along the lateral surface of the recess of the dielectric layer 210d. That is, the lateral surface of the dielectric layer 210d may be covered by the bonding layer 220. In some embodiments, the bonding layer 220 may have a substantially uniform thickness on the lateral surface of the dielectric layer 210d. In some embodiments, the recess 240c tapers toward the conductive element 250c. That is, the recess 240c may have an upper width greater than a lower width. In some embodiments, the recess 240c may be formed by a laser process. In some embodiments, the recesses 235 and 240b may be stepped. The recess 235 may form a first stage (i.e., the top surface 222a of the second portion 222 of the bonding layer 220) and the recess 240c may form a second stage (for example, the top surface of the conductive element 250c) recessed from the first stage.

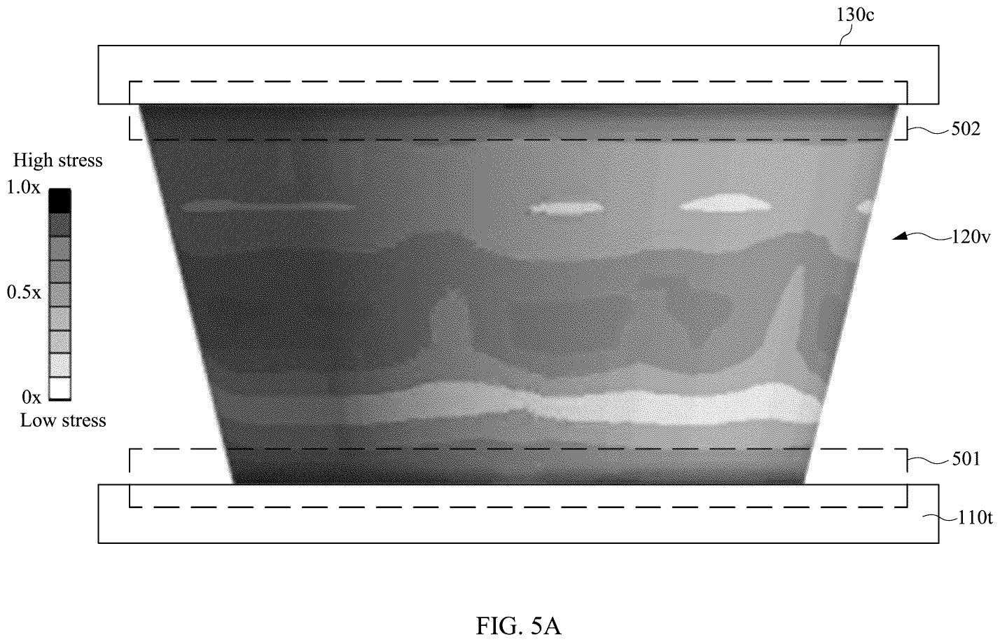

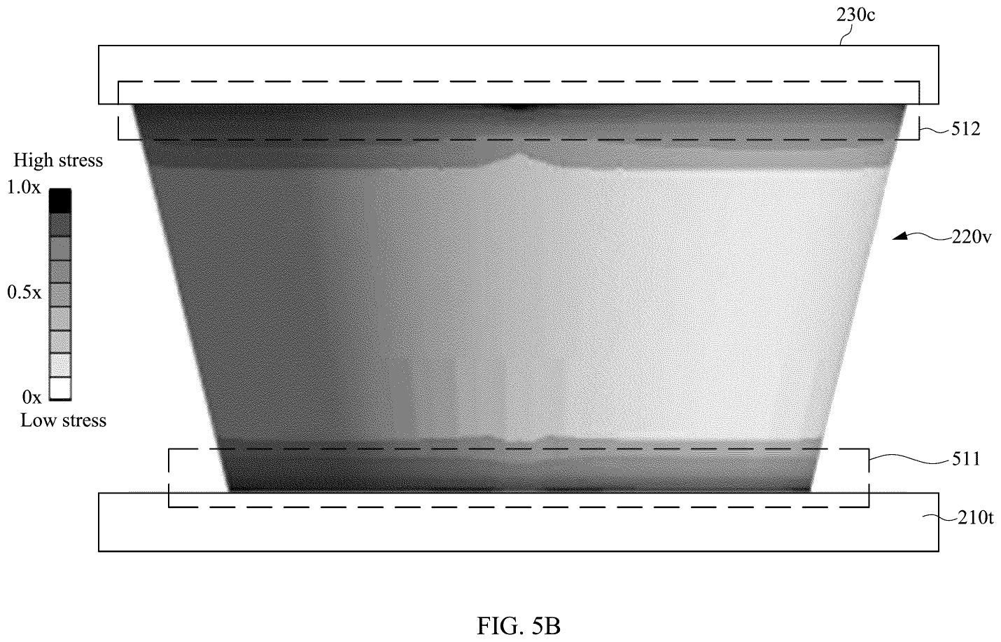

FIGS. 5A and 5B are stress simulation diagrams of an interconnector of an electronic device, in accordance with some embodiments of the present disclosure. Referring to FIG. 5A, the simulated object may be the interconnectors 120v between the pad 110t of the circuit structure 110 and conductive layer 130c of the antenna component 130A or 130B. The stress of the interconnectors 120v is distributed unevenly. The CTE mismatch, among the dielectric layers 130d, bonding layer 120, and the dielectric layers 110d, may leads to the stress mostly accumulated at the interfaces of different materials or at the curved structure after the thermal cycle processes (heat-up and cool-down processes). In particular, the stress may be accumulated at the interconnectors 120V. Therefore, the crack may occur at the dielectric layer or the conductive layer around the interconnectors 120v. The delamination may occur at the interface between the dielectric layers, at the interfaces between the conductive layers, or at the interfaces between the dielectric layer and the conductive layer.

In some embodiments, a first portion 501 between the interconnectors 120v and the pad 110t of the circuit structure 110 may incur higher stress. A second portion 502 between the interconnectors 120v and conductive layer 130c of the antenna component 130A or 130B may incur higher stress. The portion between the first portion 501 and second portion 502 may experience lower stress.

Referring to FIG. 5B, the simulated object may be the interconnectors 220v between the pads 210t of the circuit structure 210 and conductive layer 230c of the antenna component 230A or 230B. The stress of the interconnectors 120v is distributed evenly. A first portion 511 between the interconnectors 220v and the pads 210t of the circuit structure 210 may have higher stress. A second portion 512 between the interconnectors 220v and conductive layer 230c of the antenna component 230A or 230B. The portion between the first portion 511 and second portion 512 may have lower stress. Since the bonding layer 220 includes one or more recesses 240, the stress of the interconnectors 220v may be mitigated, such that delamination between the circuit structure 210 and the antenna components 230A and 230B can be reduced.

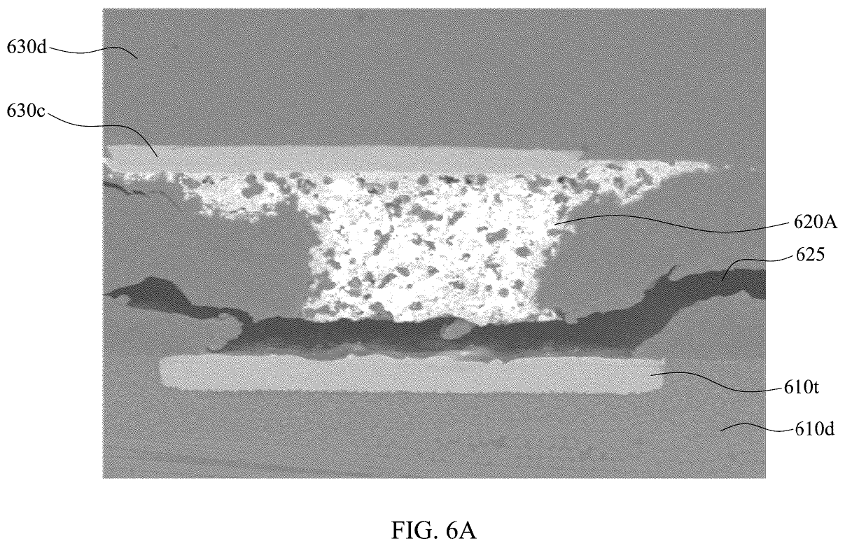

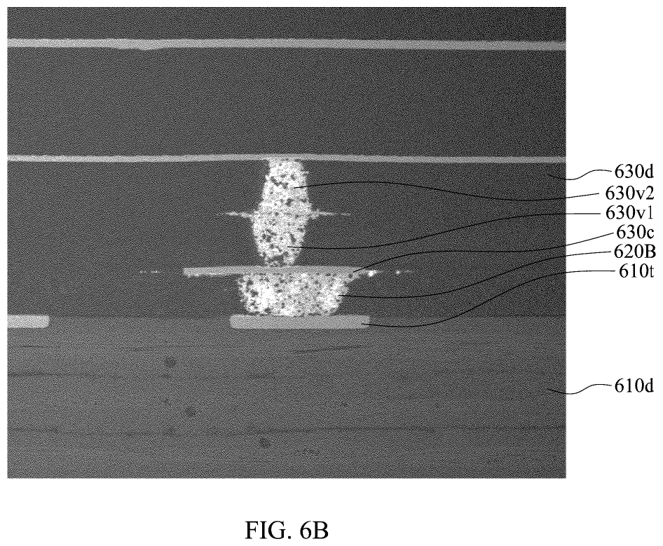

FIG. 6A is a photo showing a defect of an electronic device. Referring to FIG. 6A, the defect 625 occurs between the interconnector 620A and the conductive layer 610t, while the interconnector 620A is well bonded to the conductive layer 630c. In some embodiments, the interconnector 620A may correspond to the interconnector 120v in FIG. 1 or the interconnector 220v in FIG. 2.

FIG. 6B is a photo showing a well-adhered interconnect of an electronic device. Referring to FIG. 6B, the interconnector 620B is well bonded to the conductive layer 310t and the conductive layer 630c. One or more conductive vias 630v1 and 630v2 may be disposed on the conductive layer 630c. The conductive via 630v2 may be disposed on the conductive via 630v1. The conductive vias 630v1 and 630v2 may be aligned. The conductive vias 630v1 and 630v2 may taper in an opposite direction. For example, the conductive via 630v1 tapers toward the conductive layer 630c, and the conductive via 630v2 tapers in a direction away from the conductive via 630v1. The interconnector 620B may electrically connect the conductive layer 610t to the conductive layer 630c. In some embodiments, the conductive layer 610t may be a pad or trace in an embedded trace substrate (ETS) arrangement. That is, the top surface of the conductive layer 610t is substantially aligned with the top surface of the topmost one of the dielectric layers 610d. In some embodiments, the interconnector 620A may correspond to the interconnector 120v in FIG. 1 or the interconnector 220v in FIG. 2.

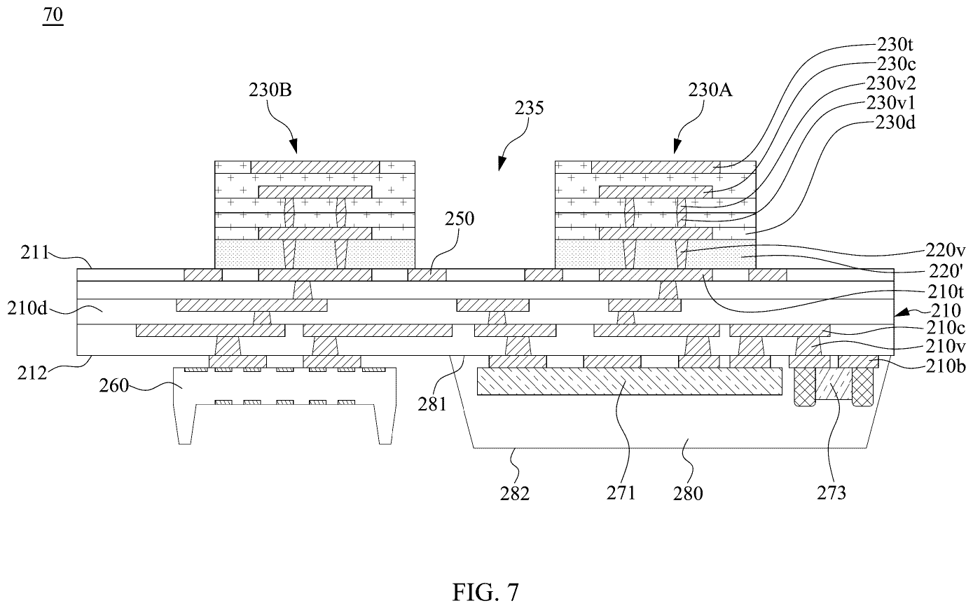

FIG. 7 is a cross-section of an electronic device 70, in accordance with some embodiments of the present disclosure. The electronic device 70 of FIG. 7 is similar to the electronic device 20 of FIG. 2, except that the electronic device 70 of FIG. 7 includes a bonding layer 220′ in a different arrangement. The bonding layer 220′ may be disposed between the circuit structure 210 and the antenna components 230A and 230B. In some embodiments, the bonding layer 220′ may vertically overlap the antenna components 230A and 230B. In some embodiments, the bonding layer 220′ may expose the top surface 211 of the circuit structure 210. In some embodiments, the recess 235 between the antenna components 230A and 230B may expose the top surface 211 of the circuit structure 210. In some embodiments, the bonding layer 220′ may have a lateral surface recessed from the lateral surface of the circuit structure 210. The bonding layer 220′ may have a width smaller than a width of the circuit structure 210.

In some embodiments, the conductive elements 250 may be embedded in the dielectric layers 210d of the circuit structure 210. The top surface of the conductive elements 250 may be exposed by the dielectric layers 210d. In some embodiments, the top surface of the conductive elements 250 may be substantially coplanar with the top surface 211 of the dielectric layers 210d. The conductive element 250 may partially be covered by the bonding layer 220′.

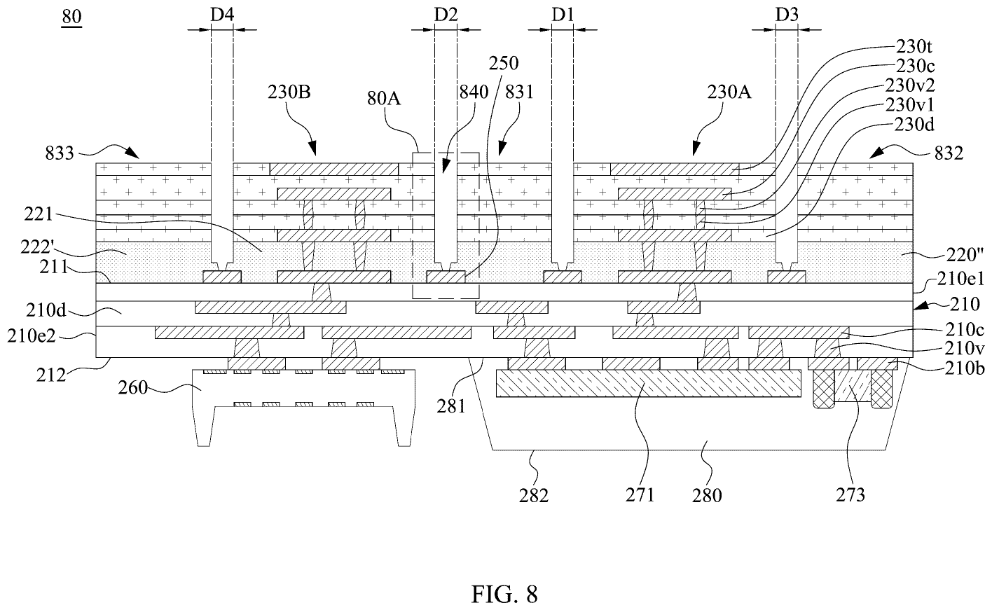

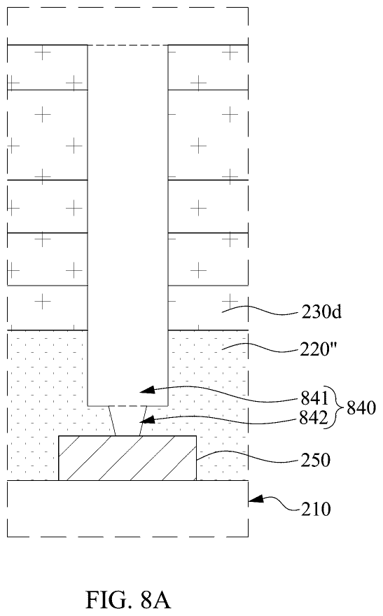

FIG. 8 is a cross-section of an electronic device 80, in accordance with some embodiments of the present disclosure. The electronic device 80 of FIG. 8 is similar to the electronic device 20 of FIG. 2, except that the electronic device 80 of FIG. 8 includes isolation structures 831, 832, and 833 adjacent to the antenna components 230A and 230B with recesses 840 separating the isolation structures 831, 832, and 833 and the antenna components 230A and 230B. In some embodiments, the electronic device 80 includes a bonding layer 220″ similar to the bonding layer 220 in FIG. 2, except that the second portion 222′ of the bonding layer 220″ is arranged in a different embodiment.

The recesses 840 may surround the antenna components 230A and 230B. The recesses 840 may penetrate the dielectric layers 230d and the bonding layer 220″ and expose a part of the conductive element 250. In some embodiments, the recesses 840 may be formed by a sawing process and/or a laser process, or other suitable removal process. The process variations of the sawing process may damage the pad or trance (for example, the pads 210t) of the circuit structure 210, and thus the removal process can be implemented with a rough removal by the sawing process and a fine removal by the laser process. Since the laser process is applied, the conductive elements 250 (or step layer) are needed to avoid the laser drilling damaging the circuit structure 210. The recess 840 may separate the dielectric layers 230d into several portions (for example, the isolation structures 831, 832, and 833). The electronic device 80 with such structure may be configured to mitigate stress between the circuit structure 210 and the antenna component 230A/230B. The details of the recesses 840 will be elaborated in FIG. 8A.

In some embodiments, the isolation structures 831, 832, and 833 may be formed with the antenna components 230A and 230B at the same time. The isolation structures 831, 832, and 833 may include the dielectric layers 230d. That is, the material of the isolation structures 831, 832, and 833 may be substantially identical to the material of the antenna components 230A and 230B. In some embodiments, the CTE of the isolation structures 831, 832, and 833 may be substantially identical to the CTE of the antenna components 230A and 230B.

Referring to FIG. 8, the isolation structures 831 are attached to the circuit structure 210 through a second portion 222′ of the bonding layer 220″. The isolation structure 831 may be disposed between the antenna components 230A and 230B. The isolation structure 831 may be disposed between the antenna components 230A and 230B and separating them. The isolation structure 831 may be separated from the antenna components 230A and 230B by the recesses 840. The isolation structure 831 may be spaced apart from the antenna component 230A by a distance D1, and spaced apart from the antenna component 230B by a distance D2. In some embodiments, each of the recesses 840 may have the same size. For example, the width of the recesses 840 may be the same. In such a case, the distance D1 may be substantially identical to the distance D2. In another embodiment, each of the recesses 840 may have different size. In such a case, the distance D1 may be different from the distance D2. For example, the distance D1 may be greater than the distance D2 (not shown). In some embodiments, the conductive elements 250 may be disposed between the isolation structure 831 and the circuit structure 210. In some embodiments, the conductive element 250 may partially overlap the antenna component 230A vertically. In some embodiments, the isolation structure 831 (and the recesses 840) may be configured to block electromagnetic interference between the antenna components 230A and 230B. In this arrangement, since there are several interfaces and medium (such as dielectric layers 230d, bonding layer 220″, and air in the recesses 840) between the antenna components 230A and 230B in the horizontal direction, the refraction/reflection of electromagnetic waves may be affected, such that the electromagnetic interference between the antenna components 230A and 230B in the horizontal direction can be reduced.

In some embodiments, the second portion 222′ of the bonding layer 220″ may be referred to as an isolation structure for separating the antenna components 230A and 230B. The second portion 222′ of the bonding layer 220″ may be disposed between the antenna components 230A and 230B and separating them.

In some embodiments, the isolation structure 832 may be disposed adjacent to the antenna component 230A. The isolation structure 832 may be disposed between the antenna component 230A and an edge 210e1 of the circuit structure 210. In some embodiments, the isolation structure 832 may be separated from the antenna component 230A by the recess 840. The isolation structure 832 may be spaced apart from the antenna component 230A by a distance D3. In some embodiments, the distance D3 may be substantially identical to the distance D1. In another embodiment, the distance D3 may be different from the distance D1. For example, the distance D3 may be greater than the distance D1.

In some embodiments, the isolation structure 833 may be disposed adjacent to the antenna component 230B. The isolation structure 833 may be disposed between the antenna component 230B and an edge 210e2 of the circuit structure 210 opposite to the edge 210e1. In some embodiments, the isolation structure 833 may be separated from the antenna component 230B by the recess 840. The isolation structure 833 may be spaced apart from the antenna component 230B by a distance D4. In some embodiments, the distance D4 may be substantially identical to the distance D1. In another embodiment, the distance D4 may be different from the distance D1. For example, the distance D4 may be greater than the distance D1. In some embodiments, the bonding layer 220″, which may be referred to as an isolation structure, may extend from the edge 210e1 to the edge 210e2.

FIG. 8A is an enlarged perspective view of a region “80A” in FIG. 8, in accordance with some embodiments of the present disclosure. Referring to FIG. 8A, the recess 840 may include a first portion 841 and a second portion 842. The first portion 841 of the recess 840 may have a substantially uniform width. The second portion 842 of the recess 840 may taper toward the circuit structure 210. The recess 840 may be a trench. The first portion 841 of the recess 840 may penetrate the dielectric layers 230d and penetrate a portion of the bonding layer 220″. The second portion 842 of the recess 840 may penetrate bonding layer 220″ to expose the conductive element 250. In some embodiments, the recess 840 may be a step structure. The first portion 841 of the recess 840 may form a first stage. The second portion 842 of the recess 840 may form a second stage (for example, the top surface of the conductive element 250a) recessed from the first stage.

In some embodiments, stress from the mismatched CTE may accumulate around the interface of the bonding layer 220″ and dielectric layers 210d and/or the interface of the bonding layer 220″ and the dielectric layers 230d. In such a case, the difference between the first CTE of the dielectric layers 210d and the second CTE of the dielectric layers 230d may lead to high stress in the interconnector 220v, and delamination may occur. The present disclosure provides an electronic device 80 with several recesses 840 removing a part of the dielectric layers 230d, whereby the bonding area of the dielectric layers 210d and the dielectric layers 230d are decreased, and stress can be mitigated. The electronic device 80 includes several isolation structures 831, 832, and 833 adjacent to the antenna components 230A and 230B and separated from the antenna components 230A and 230B by a distance. The isolation structures 831, 832, and 833 may be configured to release the stress between the circuit structure 210 and the antenna components 230A and 230B. The electronic device 80 includes less bonding area of the dielectric layers 210d and the dielectric layers 230d, whereby stress from the mismatch CTE may be decreased or eliminated. With the recesses 840, the accumulated stress between the circuit structure 210 and the antenna components 230A and 230B may be reduced. Therefore, the warpage of the electronic device 80 may be improved. In addition, the delamination situation that occur between the circuit structure 210 and the antenna components 230A and 230B can be reduced.

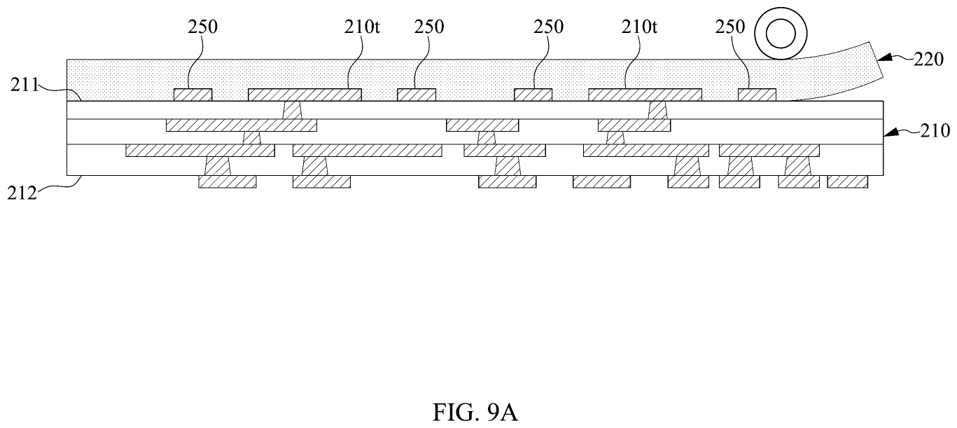

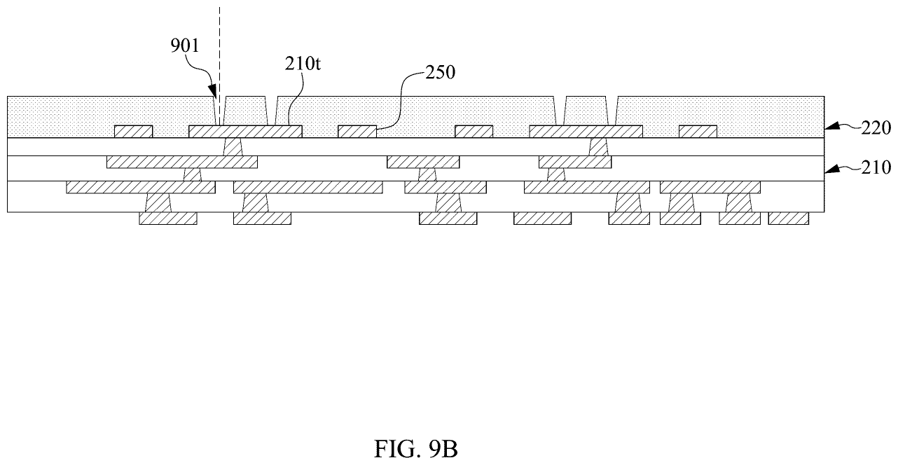

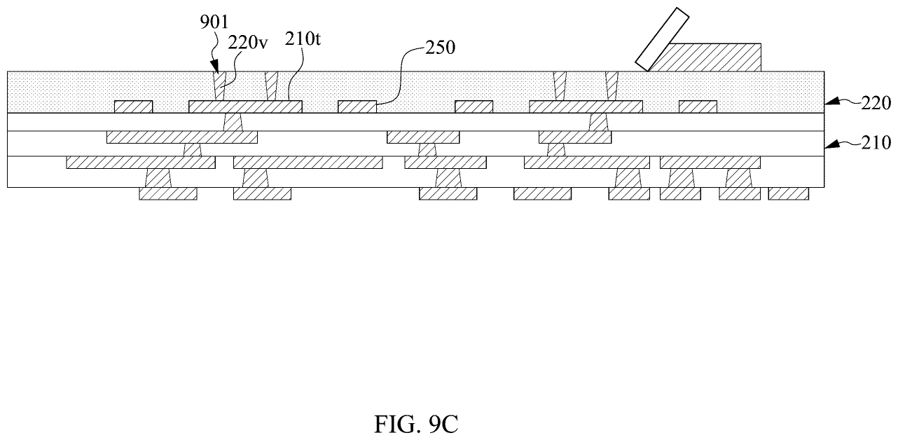

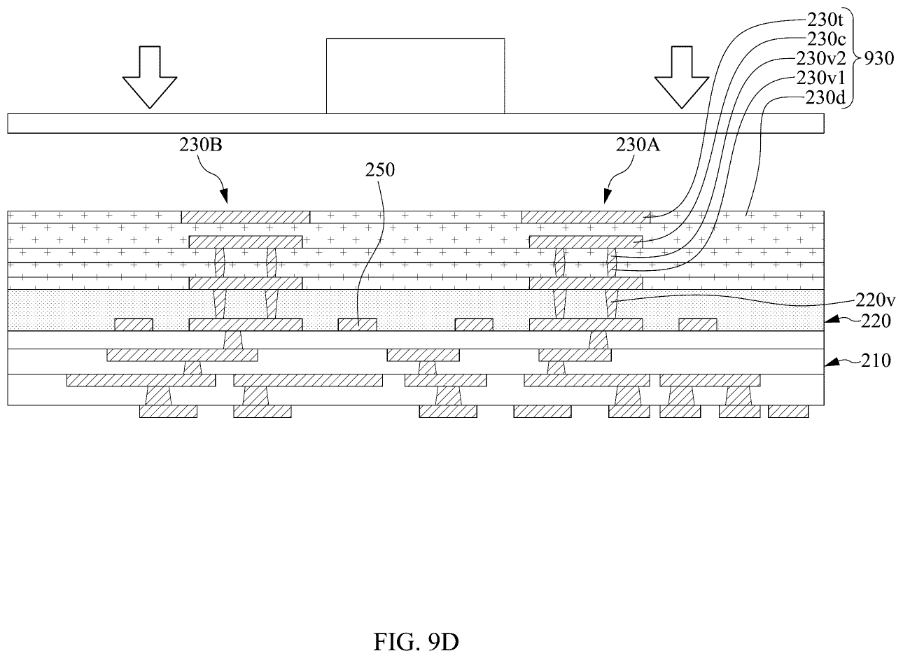

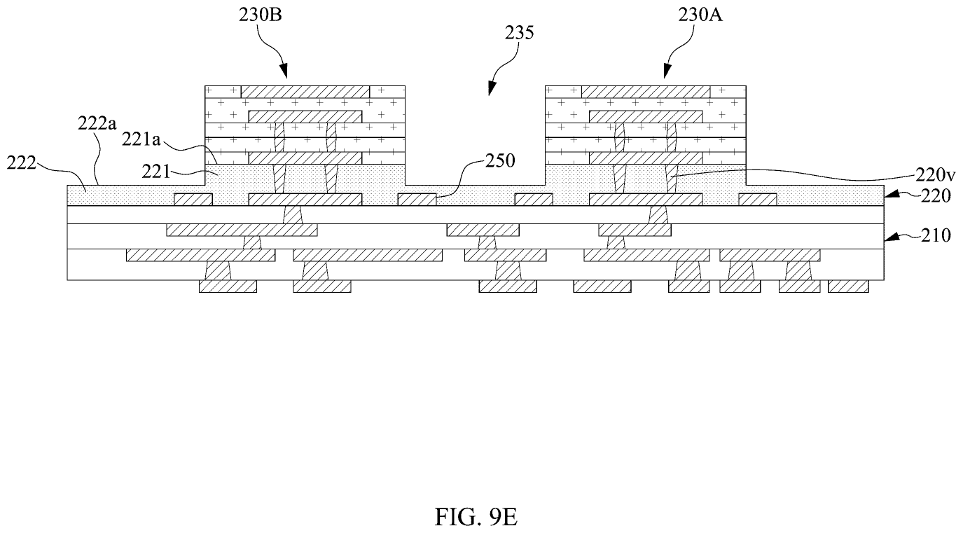

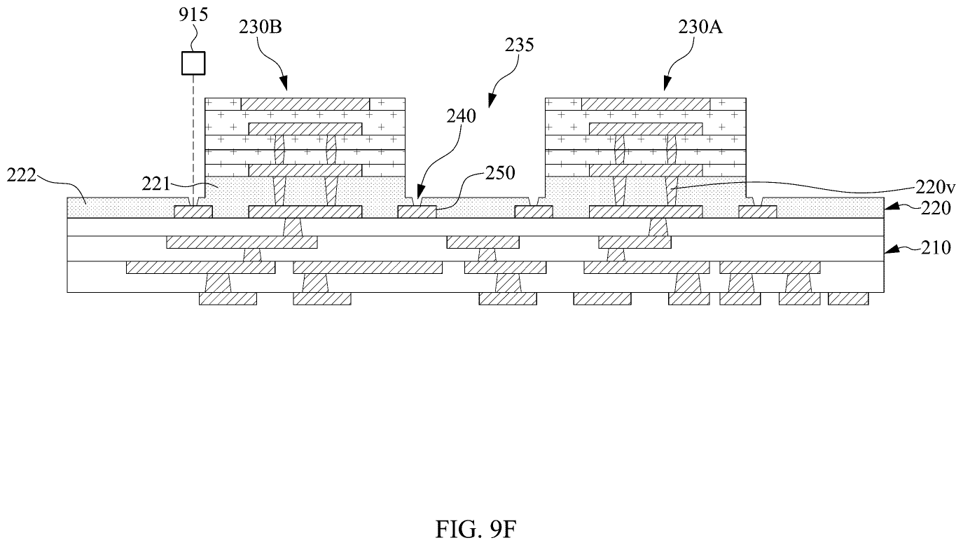

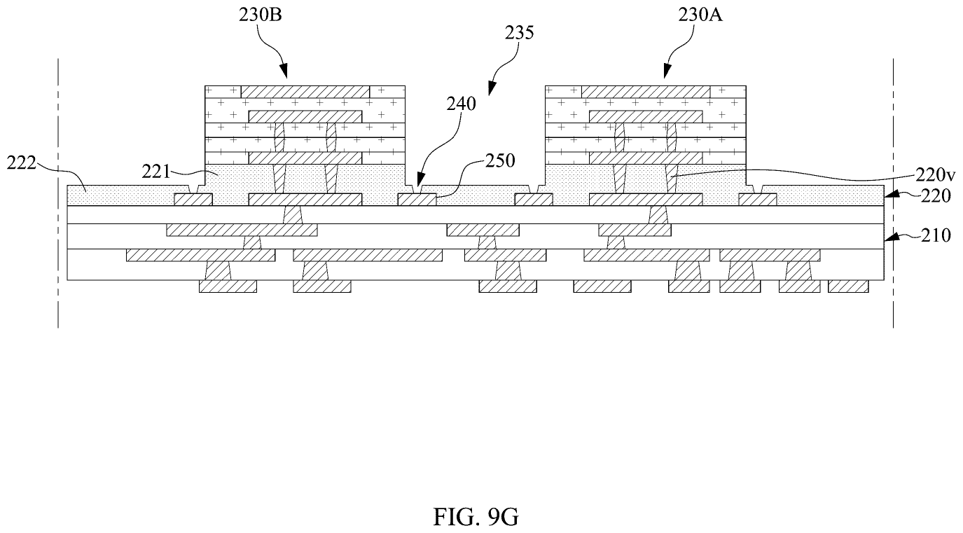

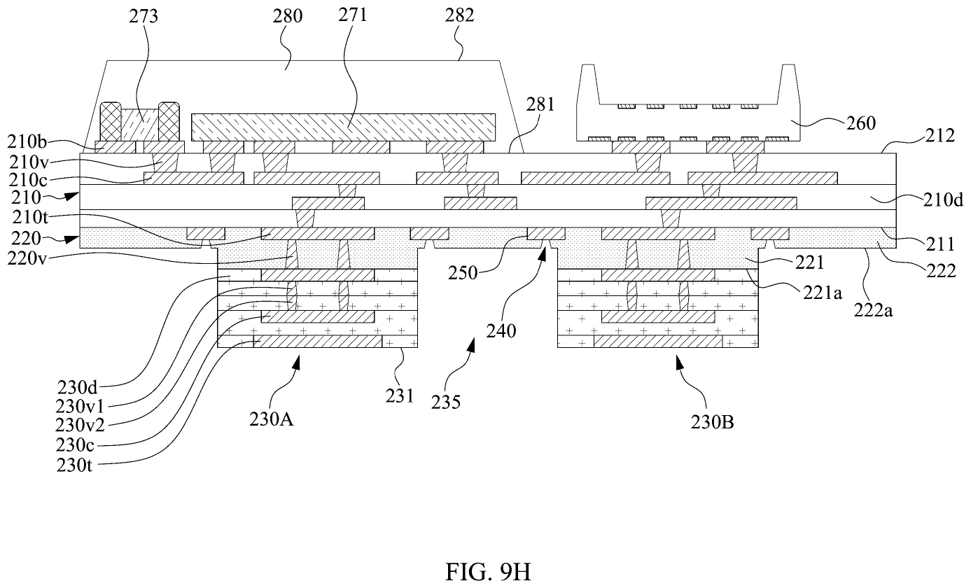

FIG. 9A, FIG. 9B, FIG. 9C, FIG. 9D, FIG. 9E, FIG. 9F, FIG. 9G, and FIG. 9H illustrate one or more operations of a method for manufacturing an electronic device, in accordance with some embodiments of the present disclosure.

Referring to FIG. 9A, a circuit structure 210 and a bonding layer 220 are provided. In some embodiments, the circuit structure 210 may have a top surface 211 and a bottom surface 212 opposite to the top surface 211. In some embodiments, the circuit structure 210 may include the pads 210t disposed on the top surface 211 of the circuit structure 210. The circuit structure 210 may include the conductive elements 250 (or the stop layer) disposed on the top surface 211 of the circuit structure 210. In some embodiments, the bonding layer 220 may be disposed on the top surface 211 of the circuit structure 210. The bonding layer 220 may cover the pads 210t and the conductive elements 250. In some embodiments, the bonding layer 220 may be laminated on the circuit structure 210. In some embodiments, FIG. 9A shows a pre-lamination process that includes a roller to flatten the bonding layer 220 on the circuit structure 210.

Referring to FIG. 9B, a removal process is performed on the bonding layer 220. In some embodiments, a laser 905 may perform a laser drill process to partially remove the bonding layer 220 to form one or more openings 901. In some embodiments, the openings 901 may penetrate the bonding layer 220 and expose the pads 210t. In some embodiments, the laser 905 may perform the removal process according to a predetermined pattern.

Referring to FIG. 9C, a conductive material is filled within the openings 901 to form the interconnectors 220v. In some embodiments, the interconnectors 220v may be disposed on and contact the pads 210t. In some embodiments, the interconnectors 220v may be conductive vias or pillars, such as conductive paste filling (CPF).

Referring to FIG. 9D, an antenna substrate 930 may be formed on the bonding layer 220. In some embodiments, the antenna substrate 930 may be a pre-formed structure. In some embodiments, the antenna substrate 930 may include the antenna components 230A and 230B and the dielectric layers 230d covering the antenna components 230A and 230B. The antenna substrate 930 may be laminated on the circuit structure 210. The antenna substrate 930 may be attached to the circuit structure 210 through the bonding layer 220.

Referring to FIG. 9E, a removal process is performed on the antenna substrate 930 and the bonding layer 220 to separate the antenna components 230A and 230B. In some embodiments, the removal process may be tape saw process, grinding process, or other suitable process. The removal process may remove the dielectric layers 230d and a portion of the bonding layer 220 to form the recess 235 between the antenna components 230A and 230B. The dielectric layers 230d and a portion of the bonding layer 220 adjacent to the edge of the circuit structure 210 may be removed. After removal process, the bonding layer 220 may include the first portion 221 between the circuit structure 210 and the antenna components 230A and 230B, and the second portion 222 having a top surface 222a lower than the top surface 221a of the first portion 221. In other words, the removal process may stop at the elevation of the top surface 222a of the second portion 222 of the bonding layer 220. In some embodiments, the removal process may remain a portion of bonding layer 220 covering the conductive elements 250. That is, the conductive elements 250 may not be exposed in FIG. 9E.

Referring to FIG. 9F, a removal process is performed on the bonding layer 220. In some embodiments, a laser 915 may perform a laser saw process to partially remove the bonding layer 220 to form one or more recesses 240. The bonding layer 220 is separated into several portions to further decrease the CTE mismatch. The thinning process (such as the tape saw process or grinding process) has larger process variations, which may damage the circuit structure 210 (such as the pads 210t or dielectric layers 210d) during cutting through the bonding layer 220. Accordingly, the laser saw process is utilized to cut through the bonding layer 220. In some embodiments, the recesses 240 may penetrate the bonding layer 220 and expose the conductive elements 250. The recesses 240 may taper toward the conductive elements 250. In some embodiments, the laser 915 may perform the removal process according to a predetermined pattern.

Referring to FIG. 9G, the resulting structure in FIG. 9F may be singulated. In some embodiments, a dicing operation may be performed on the wafer or panel. In some embodiments, the dicing operation may be a sawing process.

Referring to FIG. 9H, a connector 260 and electronic components 271 and 273 are bonded to the circuit structure 210 and an encapsulant 280 encapsulates the electronic components 271 and 273. In some embodiments, the resulting structure in FIG. 9G may be disposed upside down, and then the connector 260 and electronic components 271 and 273 may be disposed on the bottom surface 212 of the circuit structure 210. In some embodiments, the connector 260 may be connected to the pads 210b of the circuit structure 210. In some embodiments, the connector 260 may be electrically connected to the circuit structure 210 through solder material, such as solder balls (not shown). The electronic components 271 and 273 may be connected to the pads 210b of the circuit structure 210. In some embodiments, the electronic components 271 and 273 may be electrically connected to the circuit structure 210 through solder material, such as solder balls (not shown). For example, the solder balls may be disposed between the pads 210b and the electronic component 271 and between the pads 210b and the electronic component 273. The encapsulant 280 may be disposed on the bottom surface 212 of the circuit structure 210, and cover the electronic components 271 and 273. In some embodiments, the connector 260 may be free from contacting the encapsulant 280. The connector 260 may be spaced apart from the encapsulant 280 by a keep-out distance. Then, an electronic device 20 as described and illustrated with reference to FIG. 2 is formed.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be substantially flat if a displacement between a highest point and a lowest point of the surface is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device, comprising:
a circuit structure; and
an antenna component attached to the circuit structure by a connection layer,
wherein the connection layer includes a plurality of portions spaced apart from each other and configured to mitigate stress between the circuit structure and the antenna component.

2. The electronic device of claim 1, wherein the connection layer has a recess separating the plurality of portions of the connection layer, the antenna component is separated into at least two antenna units by the recess.

3. The electronic device of claim 2, further comprising a stop layer disposed on the circuit structure, wherein the stop layer is covered by the connection layer and exposed by the recess.

4. The electronic device of claim 2, wherein the antenna component includes antenna units and a trench disposed between the antenna units and separating the antenna units, wherein the trench is connected to the recess of the connection layer.

5. The electronic device of claim 1, wherein the antenna component includes a first dielectric layer and the circuit structure includes a second dielectric layer, wherein a difference between a coefficient of thermal expansion (CTE) of the connection layer and a CTE of the first dielectric layer is less than a difference between the CTE of the connection layer and a CTE of the second dielectric layer.

6. The electronic device of claim 2, wherein the recess has a first portion recessed from the antenna component and extending to the connection layer and a second portion tapering toward the circuit structure.

7. The electronic device of claim 1, wherein the connection layer exposes a portion of a top surface of the circuit structure.

8. An electronic device, comprising:
a circuit structure;
a plurality of antenna units spaced apart from each other; and
an isolation structure disposed between the plurality of antenna units and separating the plurality of antenna units, the isolation structure configured to release the stress between the circuit structure and the first antenna component.

9. The electronic device of claim 8, wherein a width of the isolation structure is less than a width of the first antenna component.

10. The electronic device of claim 8, wherein a thickness of the isolation structure is less than a thickness of the first antenna component.

11. The electronic device of claim 8, wherein the isolation structure includes a plurality of dielectric layers stacked.

12. The electronic device of claim 8, wherein the circuit structure has a first edge and a second edge opposite to the first edge, wherein the isolation structure extends from the first edge to the second edge.

13. The electronic device of claim 8, wherein at least a portion of the isolation structure is spaced apart from antenna units.

14. The electronic device of claim 13, wherein the isolation structure is configured to block electromagnetic interference between the antenna units.

15. An electronic device, comprising:
a circuit structure;
a connection layer disposed over the circuit structure; and
an antenna component attached to the circuit structure by the connection layer, wherein a part of a top surface of the connection layer is exposed by the antenna component.

16. The electronic device of claim 15, wherein the connection layer includes a first portion connecting the antenna component and the circuit structure, and a second portion connected to the circuit structure and spaced apart from the first portion.

17. The electronic device of claim 16, wherein a thickness of the first portion is greater than a thickness of the second portion.

18. The electronic device of claim 16, wherein the second portion of the connection layer is around the first portion of the connection layer.

19. The electronic device of claim 16, further comprising a conductive element including a first portion embedded in the first portion of the connecting layer and a second portion embedded in the second portion of the connecting layer.

20. The electronic device of claim 15, wherein a part of a top surface of the conductive element is exposed by the first portion and the second portion.
